(19) United States
(12) Patent Application Publication
(10) Pub. No.: US 2006/0221227 A1
(43) Pub. Date: Oct. 5, 2006

(54) Focusing method for image-capturing device

(76) Inventor: Chi-Kuei Chang, Taipei (TW)

Correspondence Address: Raymond Sun, 12420 Woodhall Way, Tustin, CA, 92782, US

(21) Appl. No.: 11/099,820

(22) Filed: Apr. 5, 2005

(51) Int. Cl. H04N 5/232

(52) U.S. Cl. 348/353

(57) ABSTRACT

A focusing method for an image-capturing device with a focus is disclosed. The focusing method first determines a maximal contrast value and a corresponding first position of the focus by a focus procedure, and determines a second position of the focus by a calibration procedure. Next, the focusing method compares the first and second positions to generate an adjustment number of steps, and then positions the focus according to the adjustment number. By applying this method, the focus error problem of the image-capturing device can be improved, thereby upgrading the resolution and performance of the image-capturing device.

### BACKGROUND OF INVENTION

1. Field of the Invention

The present invention relates in general to image capturing, and more particularly to a focusing method for image-capturing devices.

2. Description of the Prior Art

In general, when a common digital camera (or digital camcorder) performs focusing, a stepping motor is used to move the focus back and forth within the lens (the moving distance is represented by one “number of steps”), and the light penetrating the focus is received by a light sensor (e.g. CCD). Then, a digital signal processor (DSP) is used to calculate the contrast value corresponding to each different position of the focus. FIG. 1 is a diagram showing a typical correspondence between the focus step number and the contrast value when the digital camera performs focusing. The horizontal axis of FIG. 1 is the focus step number that can represent the position where the focus is located. The values of the focus step number are measured against a reference position (the origin of FIG. 1). The vertical axis of FIG. 1 is the contrast value, which is calculated according to the contrast by the DSP. In FIG. 1, the correspondence is shown as a curve with a peak value. In an ordinary situation, the peak value of the curve is an optimal contrast value, and the value of the horizontal axis corresponding to this optimal contrast value is an optimal focus step number. The digital camera should retain the best resolution when shooting at the optimal focus step number.

However, in some particular situations, a focus error may be generated such that the focus step number corresponding to the peak value of FIG. 1 is not the “optimal” focus step number. For example, if the rate of light entering the lens on the tele side is not high enough (i.e. the lens is “second-class”), the focus error may occur when the camera performs focusing on the tele side. At this time, the step number corresponding to the peak value of FIG. 1 is not the optimal focus step number that can bring the best resolution.

If the above issue is encountered in the manufacturing process of digital cameras, a conventional solution is to neglect the focus error, or to replace the second-class lens directly when the error exceeds some predetermined tolerable limit. Therefore, in the conventional approach, if it is selected to neglect the error, the resolution and performance of the manufactured camera cannot be upgraded; if replacing the second-class lens is selected, then the manufacturing cost would be increased significantly.

### SUMMARY OF INVENTION

In view of this, an object of the present invention is to provide a focusing method which can be applied in an image-capturing device (e.g. digital camera or camcorder) to improve its focus error problem and upgrade its resolution and performance.

Another object of the present invention is to provide a method for adjusting a focus step number for a digital imaging device (e.g. digital camera or camcorder) with a focus. The method can adjust the focus to an optimal focus step number, thereby achieving the best resolution for the digital imaging device.

Accordingly, in attainment of the aforementioned objects, the focusing method of the present invention comprises: performing a focus procedure to determine a first position of a focus of the image-capturing device, wherein the first position corresponds to a first contrast value; performing a calibration procedure to determine a second position of the focus; comparing the first and second positions to generate an adjustment number of steps; and positioning the focus according to the adjustment number of steps.

In another aspect, the method for adjusting the focus step number according to the present invention comprises: performing a focus procedure to determine a first step number of the focus, wherein the first step number corresponds to a first contrast value; setting the focus at a plurality of step numbers and shooting a corresponding picture at each of the step numbers; selecting a second step number from the step numbers according to file size of the corresponding pictures; comparing the first and second step numbers to generate an adjustment number of steps; and adjusting the focus step number of the focus according to the adjustment number of steps.

### BRIEF DESCRIPTION OF THE DRAWINGS

FIG. 1 is a diagram showing a typical correspondence between the focus step number and the contrast value when a digital camera performs focusing.

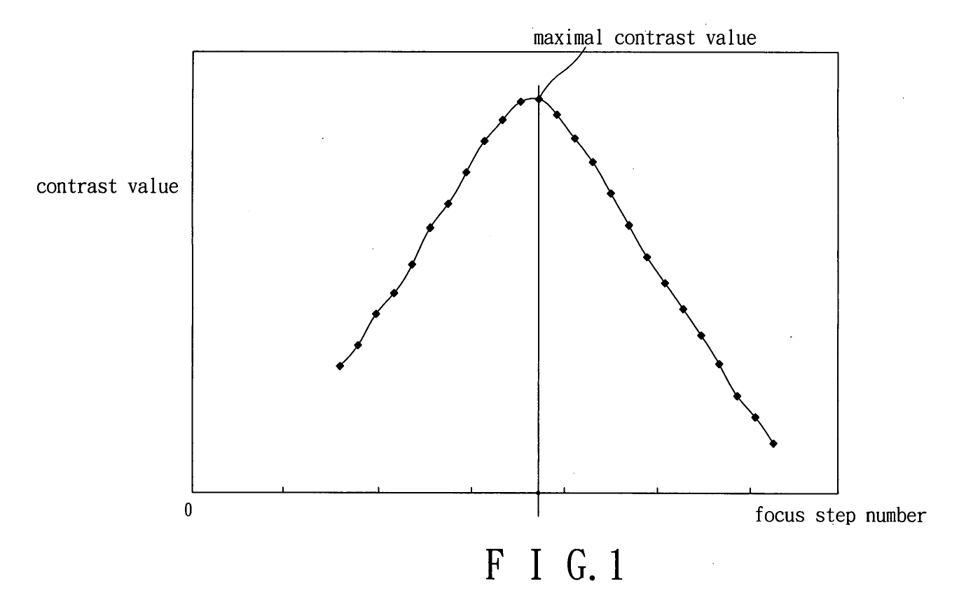

FIG. 2 is a flow chart of a preferred embodiment of the focusing method according to the present invention.

FIG. 3 is a diagram illustrating the process of performing the steps 21 to 23 of FIG. 2.

FIG. 4 is a flow chart of a preferred embodiment of the method for adjusting the focus step number according to the present invention.

### DETAILED DESCRIPTION

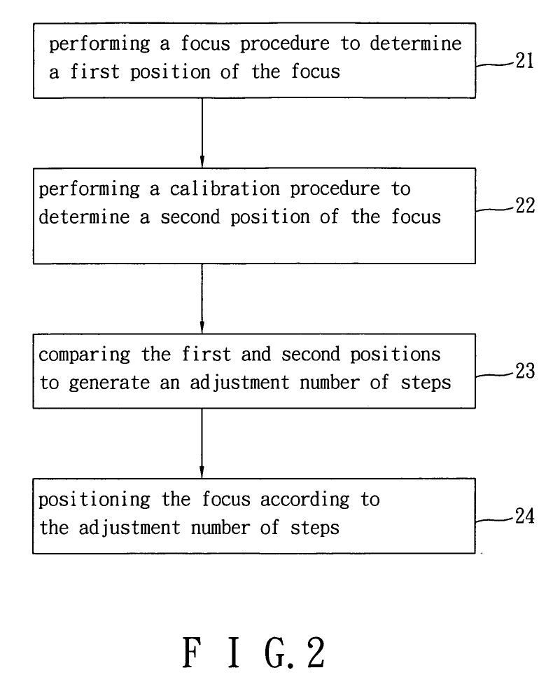

FIG. 2 is a flow chart of a preferred embodiment of the focusing method according to the present invention. In the preferred embodiment, the focusing method is applied in an image-capturing device, such as a digital camera or digital camcorder. The image-capturing device includes a focus that can move back and forth when the focusing method is performed. The moving distance of the focus is represented by one number of steps. As shown in FIG. 2, the flow comprises the steps of:
21 performing a focus procedure to determine a first position of the focus;
22 performing a calibration procedure to determine a second position of the focus;
23 comparing the first and second positions to generate an adjustment number of steps; and
24 positioning the focus according to the adjustment number of steps.

In the step 21, the focus procedure is executed by setting the focus at a plurality of positions and calculating a corresponding contrast value for each of the positions. Then, a maximal contrast value is selected and its corresponding position is determined as the first position.

In the step 22, the calibration procedure is performed according to a concept of “the larger the resolution of a lens is, the bigger the file size of a shot picture is”. That is, the calibration procedure is executed by setting the focus at a plurality of different positions and shooting a corresponding picture at each of the positions. Then, the picture with a maximal file size is selected and its corresponding position is determined as the second position. The image-capturing device can achieve an optimal resolution when setting the focus at the second position. In one embodiment, these different positions include the first position mentioned above, and the interval number of steps between any two adjacent ones of the positions is equal. For example, the different positions can be distributed among the range of fourteen steps in front and back of the first position respectively, and the interval number of steps between any two adjacent positions is 2.

Each position of the focus can be represented by a corresponding focus step number. Thus, after the first and second positions are determined, the difference between the corresponding focus step numbers of these two positions can be calculated to obtain the adjustment number of steps in the step 23. The adjustment number of steps can be considered as the focus error, and its value is determined by the properties of the lens used in the image-capturing device. A value of zero indicates no focus error.

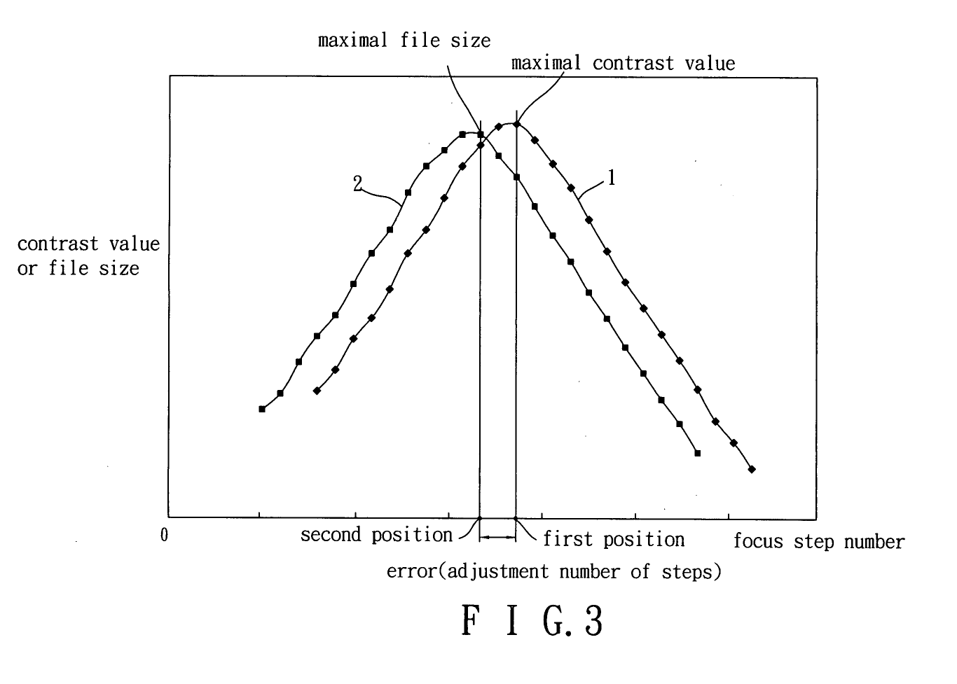

FIG. 3 is a diagram illustrating the process of performing the steps 21 to 23 of FIG. 2. In FIG. 3, a curve 1 is obtained by executing the focus procedure in the step 21. The curve 1 describes a correspondence between the focus step number (horizontal axis) and the contrast value (vertical axis), and the focus step number corresponding to the peak value of the curve 1 represents the first position. On the other hand, a curve 2 is obtained by executing the calibration procedure in the step 22. The curve 2 describes a correspondence between the focus step number (horizontal axis) and the file size (vertical axis). The peak value of the curve 2 indicates a maximal file size, and the focus step number corresponding to this peak value represents the second position. The difference number of steps between the first and second positions is the adjustment number of steps.

Then, in the step 24, the focus can be positioned according to the adjustment number of steps, thereby achieving the optimal resolution. For example, when the image-capturing device performs focusing hereafter, the focus procedure in the step 21 is first executed and the focus would be located at a position with a “supposed-to-be” maximal contrast value (here the term of “supposed-to-be” is used since there may be the focus error). Next, the focus is further moved by the adjustment number to achieve the optimal resolution. In one embodiment, the adjustment number of steps is stored in a memory of the image-capturing device. Thus, it is convenient for the image-capturing device to obtain this adjusting value when perform focusing.

Besides, the adjustment number of steps can be varied with various shooting parameters of the image-capturing device. Therefore, in another preferred embodiment of the focusing method of the present invention, one or more shooting parameters are further selected, and the steps 21 to 23 are repeatedly executed at various setting values of the shooting parameters, thereby generating corresponding adjustment numbers of steps. The correspondence between the shooting parameters and these adjustment numbers can also be stored in the memory of the image-capturing device. Then in the step 24, based on the current setting values of the shooting parameters, the corresponding adjustment number of steps is read from the memory and the location of the focus is adjusted according to the read value. The selection of the shooting parameters depends on the accuracy required. In principle, the more the parameters are selected, the less the focus error is caused. In one embodiment, zoom step and shooting distance are selected.

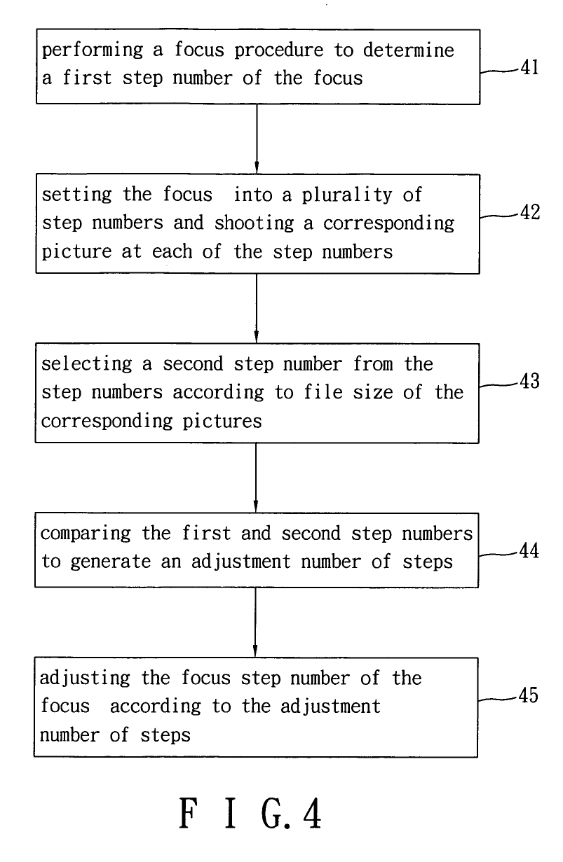

FIG. 4 is a flow chart of a preferred embodiment of the method for adjusting the focus step number according to the present invention. In this preferred embodiment, the adjusting method is applied in a digital imaging device, such as a digital camera or digital camcorder. The digital imaging device includes a focus that can move back and forth when the adjusting method is applied. The moving distance of the focus is represented by one number of steps. As shown in FIG. 4, the flow comprises the steps of:
41 performing a focus procedure to determine a first step number of the focus;
42 setting the focus at a plurality of different step numbers and shooting a corresponding picture at each of the step numbers;
43 selecting a second step number from the step numbers according to file size of the corresponding pictures;
44 comparing the first and second step numbers to generate an adjustment number of steps; and
45 adjusting the focus step number of the focus according to the adjustment number of steps.

In the step 41, similar to the step 21 in FIG. 2, the focus procedure is executed by setting the focus at a plurality of step numbers and calculating a corresponding contrast value for each of the step numbers. Then, a maximal contrast value is selected and its corresponding step number is determined as the first step number.

In the step 42, the different step numbers include the first step number mentioned above, and the interval between any two adjacent step numbers is equal. In the step 43, the second step number corresponds to the picture with a maximal file size. In the step 44, the difference between the first and second step numbers is calculated to obtain the adjustment number of steps. In one embodiment, the obtained adjustment number is stored in a memory of the digital imaging device for subsequent usage.

In another preferred embodiment of the adjusting method of the present invention, one or more shooting parameters are further selected, and the steps 41 to 44 are repeatedly executed at various setting values of the shooting parameters, thereby generating corresponding adjustment numbers of steps. The correspondence between the shooting parameters and these adjustment numbers can be stored in the memory of the digital imaging device. Then in the step 45, based on the current setting values of the shooting parameters, the corresponding adjustment number of steps is read from the memory and the location of the focus is adjusted according to the read value. In one embodiment, zoom step and shooting distance are selected.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A focusing method for an image-capturing device with a focus comprising:
performing a focus procedure to determine a first position of the focus, wherein the first position corresponds to a first contrast value;
performing a calibration procedure to determine a second position of the focus;
comparing the first and second positions to generate an adjustment number of steps; and
positioning the focus according to the adjustment number of steps.

2. The focusing method of claim 1, further comprising:
storing the adjustment number of steps into a memory of the image-capturing device.

3. The focusing method of claim 1, wherein the image-capturing device is a digital camera or digital camcorder.

4. The focusing method of claim 3, wherein the calibration procedure comprises:
setting the focus at a plurality of positions and shooting a corresponding picture at each of the positions; and
selecting the second position from the positions according to file size of the corresponding pictures.

5. The focusing method of claim 4, wherein the second position corresponds to one of the corresponding pictures with a maximal file size.

6. The focusing method of claim 4, wherein the positions comprise the first position.

7. The focusing method of claim 4, wherein an interval number of steps between any two adjacent ones of the positions is equal.

8. The focusing method of claim 3, wherein the focus procedure comprises:
setting the focus at a plurality of positions and calculating a corresponding contrast value for each of the positions.

9. The focusing method of claim 8, wherein the first contrast value is a maximal one of the corresponding contrast values.

10. The focusing method of claim 3, further comprising:
setting a shooting parameter of the image-capturing device as a plurality of values and repeatedly executing the focus procedure performing step, the calibration procedure performing step and the comparing step to obtain the adjustment number of steps corresponding to each of the values.

11. The focusing method of claim 10, wherein the positioning step comprises:
positioning the focus according to the shooting parameter and the corresponding adjustment numbers.

12. The focusing method of claim 10, wherein the shooting parameter is zoom step.

13. The focusing method of claim 10, wherein the shooting parameter is shooting distance.

14. A method for adjusting a focus step number for a digital imaging device with a focus, the method comprising:
performing a focus procedure to determine a first step number of the focus, wherein the first step number corresponds to a first contrast value;
setting the focus at a plurality of step numbers and shooting a corresponding picture at each of the step numbers;
selecting a second step number from the step numbers according to file size of the corresponding pictures;
comparing the first and second step numbers to generate an adjustment number of steps; and
adjusting the focus step number of the focus according to the adjustment number of steps.

15. The method of claim 14, wherein the digital imaging device is a digital camera or digital camcorder.

16. The method of claim 14, further comprising:
storing the adjustment number of steps into a memory of the digital imaging device.

17. The method of claim 14, wherein the second step number corresponds to one of the corresponding pictures with a maximal file size.

18. The method of claim 14, wherein the step numbers comprise the first step number.

19. The method of claim 14, wherein an interval between any two adjacent ones of the step numbers is equal.

20. The method of claim 14, further comprising:
setting a shooting parameter of the digital imaging device as a plurality of values and obtaining a corresponding adjustment number of steps for each of the values.

21. The method of claim 20, wherein the adjusting step comprises:
adjusting the focus step number of the focus according to the shooting parameter and the corresponding adjustment numbers.

22. The method of claim 20, wherein the shooting parameter is zoom step.

23. The method of claim 20, wherein the shooting parameter is shooting distance.
